(19) United States
(12) Patent Application Publication
(10) Pub. No.: US 2015/0220634 A1
(43) Pub. Date: Aug. 6, 2015

(54) DIGITAL MIXED TAPES

(71) Applicant: Apple Inc., Cupertino, CA (US)

(72) Inventor: Gregory F. Hughes, San Jose, CA (US)

(21) Appl. No.: 14/688,673

(22) Filed: Apr. 16, 2015

Related U.S. Application Data
(63) Continuation of application No. 13/481,405, filed on May 25, 2012.

(51) Int. Cl. G06F 17/30

(52) U.S. Cl. CPC G06F 17/30749

(57) ABSTRACT

Disclosed herein are systems, methods, and non-transitory computer-readable storage media for gifting a personalized album. A system is described that includes generating a personalized album from a request and subsequently gifting the personalized album to another party. The personalized album can include playback attributes stored in a file associated with the album or alternatively in metadata of the media items to be gifted. The playback attributes can limit playback of the album to a particular playback sequence or configure playback to reveal the names of media items as they are presented to the user. The personalized album can be accepted, rejected, or re-gifted by the recipient.

### CROSS-REFERENCE TO RELATED APPLICATIONS

This application is a Continuation of U.S. Non-Provisional Patent Application No. 13/481,405, filed on May 25, 2012, entitled “DIGITAL MIXED TAPES,” the content of which is incorporated herein by reference in its entirety.

### BACKGROUND

1. Technical Field

The present disclosure relates generally to sharing digital media content and, more specifically, to techniques and systems for personalizing and gifting an album of digital songs to another.

2. Introduction

In recent years, electronic devices capable of playing digital music have become commonplace. For instance, electronic devices such as laptop computers, handheld digital media players, smart phones, and handheld gaming systems are used daily by society to listen to music. As a result of the growing popularity of these electronic devices, the sale of digital music has grown dramatically. Consumers can visit an online store to purchase digital music as a single track or a complete album.

However, the digital age has lost some of the personalization that was available during the analog age. For example, the creation and gifting of a cassette mixed tape was a popular activity between two parties. The compilation of songs would be recorded on a cassette tape and given to another on a special occasion such as a birthday or on Valentine's Day. Cassette tapes had their drawbacks however. For instance, the artists were never appropriately compensated for the music that was recorded on the cassette mixed tape.

While there have been many advancements in the use and distribution of digital music, there is still a need for improved techniques for personalizing gifts of digital music.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations, particularly, pointed out in the appended claims. These and other features of the disclosure will become more fully apparent from the following description and appended claims, or can be learned by the practice of the principles set forth herein.

Disclosed are systems, methods, and non-transitory computer-readable storage media for gifting and personalizing digital media. The digital media can include audio songs, videos, movies, images, photos, and other digital media content. A user can submit a request for a personalized album such as a digital mixed tape by selecting a plurality of media items. The request can also include options to personalize the album, such as setting the playback sequence or revealing the name of the media items one at a time as they are presented to the user. The request can be received and processed by an online store, which in turn generates and transmits data to a recipient's device to create the personalized album on the recipient's device. Once the recipient has accepted the gift, the sending party can be charged a fee for gifting the personalized album. The recipient can be specified using a name, account ID, email address, social network ID, or other identification.

In some examples, the recipient can choose to accept, reject, or re-gift the gift. For example, the online store can notify the recipient of the gift and request a response from the recipient as to whether the recipient would like to accept or reject the gift. Depending on the recipient's response, the gift can be added to the recipient's media library, cancelled and credited back to the user, or added to a third party's media library. News of the recipient's choice can be broadcasted to multiple services or devices associated with the recipient. If the recipient rejects the gift, the online store can credit back or not charge the giftor a fee associated with gifting the personalized album. Alternatively if the recipient accepts the gift, the online store can charge the giftor a fee associated with gifting the personalized album and update the media library associated with the recipient's account. In another example, the recipient can also be presented with another option to re-gift the personalized album to a third party.

Generating the personalized album can require editing the metadata in the media items. In some examples, the editing can occur on the online store. For example, the online store can edit the album title, creator field, album art, playback sequence number, etc. of a media item to generate the personalized album. In other examples, instructions can be provided to the recipient, thus allowing the editing to occur on the recipient's device. This can prevent master copies of the media items from being edited on the online store or storing multiple copies of a media item on the online store, thus minimizing complexity and storage space on the online store. Instructions for editing media items to generate the personalized album can be stored and transmitted to the recipient in a personalization file.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof, which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary system embodiment;

FIG. 2 illustrates an exemplary cloud computing system;

FIG. 3 illustrates an exemplary system for gifting personalized albums;

FIG. 4 illustrates an exemplary process for gifting a personalized album to a recipient;

FIG. 5 illustrates another exemplary process for gifting a personalized album to a recipient;

FIG. 6 illustrates another exemplary process for gifting a personalized album to a recipient;

FIG. 7 illustrates an exemplary user interface embodiment for selecting a media item to include in the personalized album;

FIG. 8 illustrates an exemplary user interface embodiment for creating a personalized album;

FIG. 9 illustrates an exemplary user interface embodiment for presenting a personalized album;

FIGS. 10a-10d illustrate an exemplary personalized album having a playback attribute;

FIGS. 11a-11d illustrate an exemplary personalized album having two playback attributes;

FIG. 12 illustrates an exemplary notification;

FIG. 13 illustrates another exemplary notification; and

FIG. 14 illustrates an exemplary process for providing a personalized album to a recipient.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The present disclosure addresses the need in the art for systems, techniques, and methods for personalizing gifts of digital media items. The digital media can include electronic books (eBooks), digital songs, movies, videos, images, photos, and other digital media content. While the disclosure focuses on personalizing gifts of digital songs and packaging the gift as a personalized album, it is to be understood by a person of ordinary skill in the relevant art that these teachings can also be applied to gifting of other digital media items such as movies, photos, images, video clips, etc. As songs (or other digital media) are presented on an electronic device running a media player application, several songs can be selected by the user to be part of a personalized album. Other content or personalization settings can also be set by the user to personalize the album. For instance, additional content can be associated to a song in the personalized album so that the additional content can be presented before, during, or after playback of the song. In one example, the additional content can be a photo slideshow that is presented to the user during playback of the song or album. The additional content can be selected by the creator of the album or alternatively, be automatically selected by an online store or cloud service with access to content associated with the recipient of the album. Personalization settings such as playback attributes can also be set by the user to restrict the playback sequence to a specific order or to prevent skipping, fast forwarding, or rewinding of songs during playback. The selected songs, additional content, and personalization settings can be transmitted to a server or online store, which in turn transmits the album to the recipient's device. In some examples, the personalization settings and/or additional content can be stored as metadata on the selected songs. Digital audio songs contain metadata consisting of information such as artist name, album title, sequential order, the year the song was released, etc. This metadata can be augmented or changed by the giftor, for purposes such as generating a personalized album. For example, fields can be included in the metadata to enforce playback of a media item without fast forwarding or rewinding or to prevent skipping of the song. In some examples, the personalized album can be created on the server. The server can maintain a database containing master copies of all songs along with a second copy of the selected songs that have had their metadata modified, so that the songs appear on a media player application as belonging to the personalized album. Secondary copies of the songs do not need to be stored on the server however. For instance in another process, the server can copy an original media file into a temporary location, mutate the copy by editing the metadata so that the copy appears to belong to the personalized album, and then provide the copy for download. Once the copy has been downloaded, the media file stored in the temporary location can be erased. In other examples, the personalized album can be created by the playback device of the recipient. The server can maintain a single copy of all songs and instead transmit the songs along with a personalization file. The personalization file can include the playback attributes and instructions for editing the metadata associated with media items in the personalized album. The application maintaining the media library of the recipient can use the instructions to edit the metadata of the songs so that they appear on the media player application as belonging to the same album. This implementation saves disk space on the server by avoiding the need to maintain a copy of the personalized songs and albums (i.e., copy resides only on the recipient's music library). The personalization files can be created shortly before download and temporarily stored. Thus, the personalization files do not need to be stored on the server.

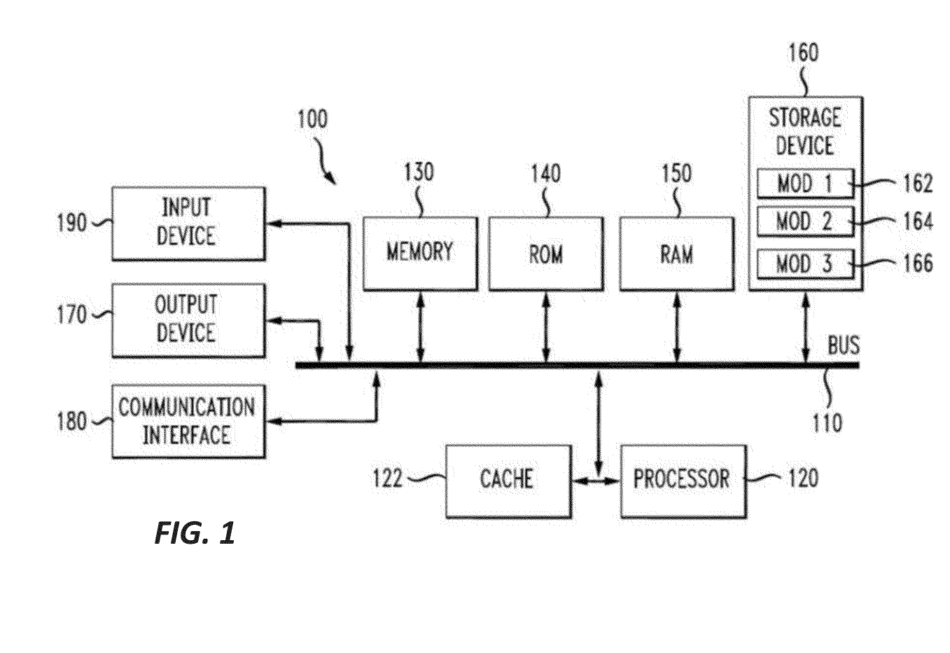

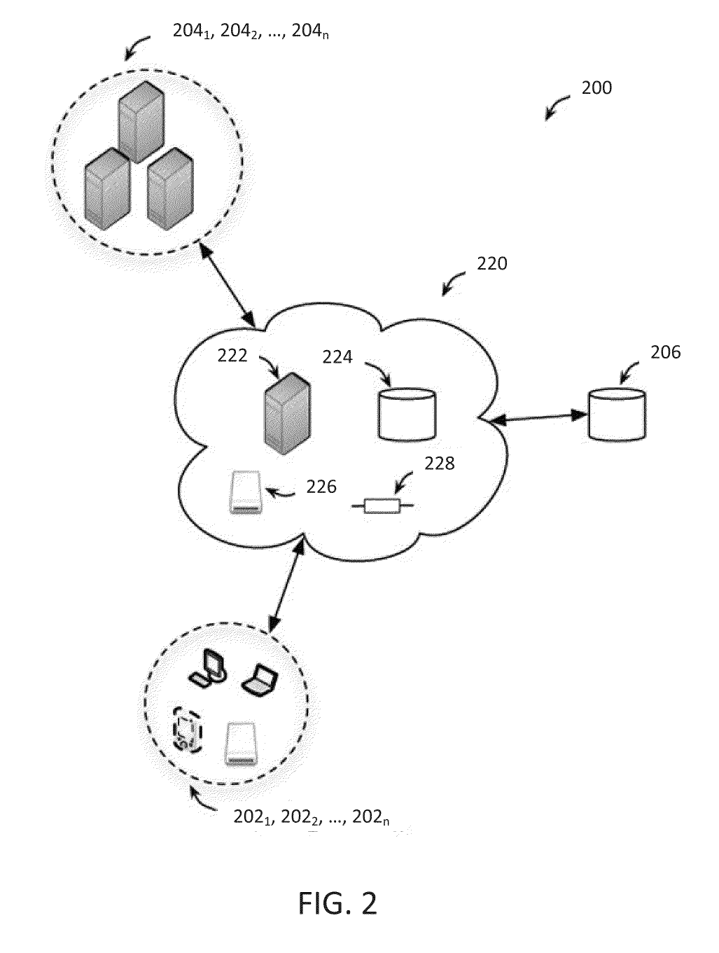

A detailed discussion of the methods and systems surrounding the concept of personalizing a music album for gifting is provided below. First, a brief introductory description of a basic general purpose system or computing device which can be employed to practice the concepts is illustrated in FIG. 1. This is followed by an introductory description of a cloud computing system in FIG. 2. A detailed description of gifting techniques for music albums will follow. Several variations shall be discussed herein as the various embodiments are set forth. The disclosure now turns to FIG. 1.

### GENERAL SYSTEM

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, a solid state drive, a tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks, including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example, the functions of one or more processors, presented in FIG. 1, may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100, shown in FIG. 1, can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored, as would be known in the art, in other computer-readable memory locations. Having disclosed some components of a computing system, the disclosure now turns to a description of cloud computing.

### CLOUD COMPUTING SYSTEM

Cloud computing is a type of Internet-based computing in which a variety of resources are hosted and/or controlled by an entity and made available by the entity to authorized users via the Internet. An exemplary cloud computing system configuration 200 is illustrated in FIG. 2 wherein a variety of electronic devices can communicate via a network for purposes of exchanging content and other data. The system can be configured for use on a wide variety of network configurations that facilitate the intercommunication of electronic devices. For example, each of the components of system 200, in FIG. 2, can be implemented in a localized or distributed fashion in a network.

System 200 can be configured to include cloud computing resources 220 (i.e., “the cloud”). The cloud resources can include a variety of hardware and/or software resources, such as cloud servers 222, cloud databases 224, cloud storage 226, cloud networks 228, cloud applications, cloud platforms, and/or any other cloud-based resources. In some cases, the cloud resources are distributed. For example, cloud storage 226 can include multiple storage devices. In some cases, cloud resources can be distributed across multiple cloud computing systems and/or individual network enabled computing devices. For example, cloud computing resources 220 can communicate with servers 204₁, 204₂, . . . , 20ₙ (collectively “204”), database 206, and/or any other network enabled computing device to provide the cloud resources.

Furthermore, in some cases, the cloud resources can be redundant. For example, if cloud computing resources 220 is configured to provide data backup services, multiple copies of the data can be stored such that the data is still be available to the user even if a storage resource is offline, busy, or otherwise unavailable to process a request. In another example, if cloud computing resources 220 is configured to provide software, the software can be available from different cloud servers so that the software can be served from any of the different cloud servers. Algorithms can be applied such that the closest server or from the server with the lowest current load is selected to process a given request.

In system 200, a user interacts with cloud computing resources 220 through user terminals 202₁, 202₂, . . . , 202ₙ (collectively “202”) connected to a network by direct and/or indirect communication. Cloud computing resources 220 can support connections from a variety of different electronic devices, such as servers; desktop computers; mobile computers; handheld communications devices, e.g., mobile phones, smart phones, tablets; set top boxes; network-enabled hard drives; and/or any other network-enabled computing devices. Furthermore, cloud computing resources 220 can concurrently accept connections from and interact with multiple electronic devices. Interaction with the multiple electronic devices can be prioritized or occur simultaneously.

Cloud computing resources 220 can provide cloud resources through a variety of deployment models, such as public, private, community, hybrid, and/or any other cloud deployment model. In some cases, cloud computing resources 220 can support multiple deployment models. For example, cloud computing resources 220 can provide one set of resources through a public deployment model and another set of resources through a private deployment model.

In some configurations, a user terminal 202 can access cloud computing resources 220 from any location where an Internet connection is available. However, in other cases, cloud computing resources 220 can be configured to restrict access to certain resources such that a resource can only be accessed from certain locations. For example, if cloud computing resources 220 is configured to provide a resource using a private deployment model, then cloud computing resources 220 can restrict access to the resource, such as by requiring that a user terminal 202 access the resource from behind a firewall.

Cloud computing resources 220 can provide cloud resources to user terminals 202 through a variety of service models, such as Software as a Service (SaaS), Platforms as a service (PaaS), Infrastructure as a Service (IaaS), and/or any other cloud service models. In some cases, cloud computing resources 220 can provide multiple service models to a user terminal 202. For example, cloud computing resources 220 can provide both SaaS and IaaS to a user terminal 202. In some cases, cloud computing resources 220 can provide different service models to different user terminals 202. For example, cloud computing resources 220 can provide SaaS to user terminal 202₁ and PaaS to user terminal 202₂.

In some cases, cloud computing resources 220 can maintain an account database. The account database can store profile information for registered users. The profile information can include resource access rights, such as software the user is permitted to use, maximum storage space, etc. The profile information can also include usage information, such as computing resources consumed, data storage location, security settings, personal configuration settings, etc. In some cases, the account database can reside on a database or server remote to cloud computing resources 220 such as servers 204 or database 206.

Cloud computing resources 220 can provide a variety of functionality that requires user interaction. Accordingly, a user interface (UI) can be provided for communicating with cloud computing resources 220 and/or performing tasks associated with the cloud resources. The UI can be accessed via an end user terminal 202 in communication with cloud computing resources 220. The UI can be configured to operate in a variety of client modes, including a fat client mode, a thin client mode, or a hybrid client mode, depending on the storage and processing capabilities of cloud computing resources 220 and/or the user terminal 202. Therefore, a UI can be implemented as a standalone application operating at the user terminal in some embodiments. In other embodiments, a web browser-based portal can be used to provide the UI. Any other configuration to access cloud computing resources 220 can also be used in the various embodiments.

As described above, in some configurations, the cloud computing resources can be used to store user data. The present disclosure contemplates that, in some instances, this gathered data might include personal and/or sensitive data. The present disclosure further contemplates that the entities responsible for the collection, analysis, disclosure, transfer, storage, or other use of such data should implement and consistently use privacy policies and practices that are, generally recognized, meeting or exceeding industry or governmental requirements for maintaining personal information data private and secure. For example, personal data from users should be collected for legitimate and reasonable uses of the entity and not shared or sold outside of those legitimate uses. Further, such collection should occur only after the informed consent of the users. Additionally, such entities should take any needed steps for safeguarding and securing access to such personal data and ensuring that others with access to the personal data adhere to their privacy and security policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal data. That is, the present disclosure contemplates that hardware and/or software elements can be provided to prevent or block access to such personal data. For example, the present technology can be configured to allow users to select the data that is stored in cloud storage. In another example, the present technology can also be configured to allow a user to specify the data stored in cloud storage that can be shared with other users.

Therefore, although the present disclosure broadly covers use of personal data to implement one or more various disclosed embodiments, the present disclosure also contemplates that the various embodiments can also be implemented without the need for accessing such personal data. That is, the various embodiments of the present technology are not rendered inoperable due to the lack of all or a portion of such personal data. For example, non-personal data can be stored in cloud storage.

### CREATING A PERSONALIZED ALBUM

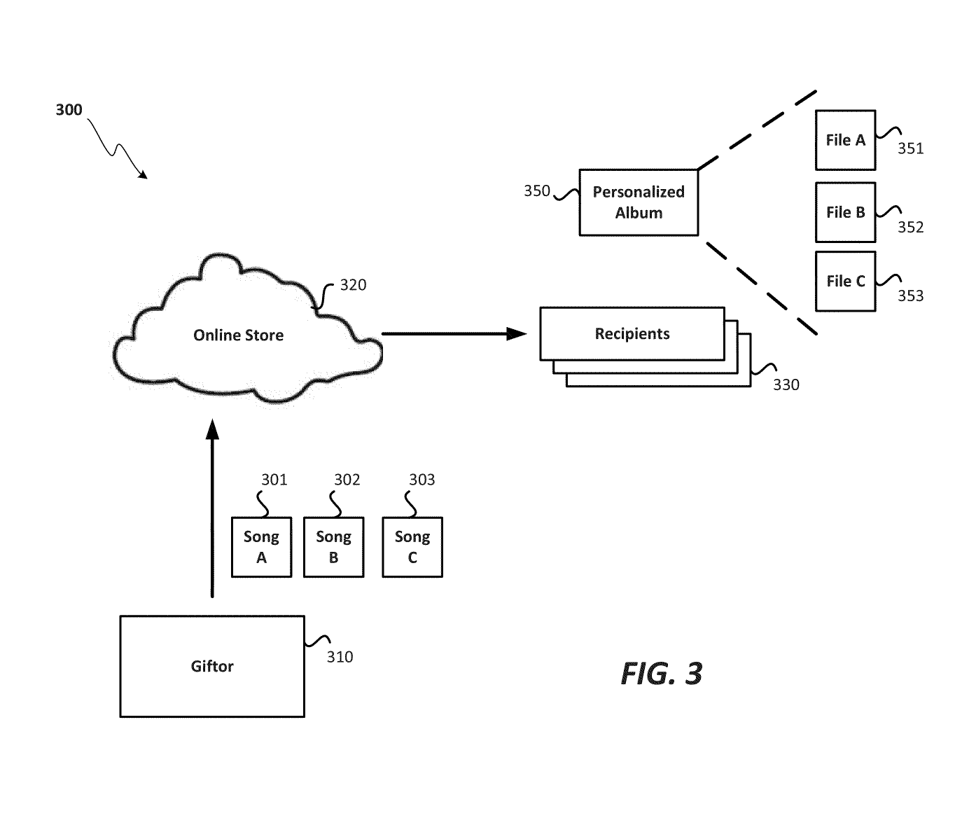

FIG. 3 illustrates an exemplary system for gifting personalized albums. Gifting system 300 includes giftor 310 (also known as donor or sender), online store 320, and one or more recipients 330 (also known as donee or giftee). The online store 320 can store a database of available media items. The media items can include audio tracks, video tracks, eBooks, images, photos, and other digital content. As new digital content becomes available, the new media items can be hosted on online store 320. Online store 320 can also maintain user accounts for users of the online store. The user accounts can include a list of media items a particular user has rights and thus the ability to access or download. In some examples, the list of media items can be items that the user has previously purchased or otherwise acquired the right to play. The user accounts can also include payment information thus allowing a user to purchase new content from the online store. In some examples, the online store can be implemented using one or more of cloud computing resources 220 described in FIG. 2.

Giftor 310 can select a plurality of songs that are to be part of a personalized album. The selected songs can be from the giftor's music library or alternatively from songs available on online store 320. As shown here, giftor 310 has selected Song A 301, Song B 302, and Song C 303. These song selections can be transmitted along with a personalized album request to online store 320. The online store receives the data from giftor 310 and in response, generates a personalized album including audio files associated with the selected songs. The personalized album is then transmitted to one or more recipients 330. In some examples, the audio files in the personalized album can be personalized. In one embodiment, the personalization can include modification of metadata associated with the song. Generally, digital audio files contain metadata that is used to specify information related to the song such as the album that the song belongs to, the artist of the song, the genre, and other attributes of the song. In a personalized copy of the audio file, the metadata can be edited to specify that the song belongs to the personalized album (by editing the album title field) or that giftor 310 created the album (by editing the creator or composer field). This allows a listener to search a media library for a particular song by using the metadata of the song. For instance, a listener can query a media library based on a genre, album, artist, creator, composer, date of release, or other attribute of the song.

In another embodiment, the personalization can include associating other media content with the song. Other media content can be audio, video, an image, or a slide show presentation that is presented before, during, or after playback of the song. The additional content can be selected by the creator of the album or alternatively, be automatically selected by online store 320. The automatic selection can be performed by querying data accessible to online store 320 for media that is associated with the recipient(s). For example, a query can be performed for media that is associated with a recipient's unique identifier. This can allow the system to further personalize the album to create a unique experience for a particular recipient.

In some examples, album metadata, personalized audio files, and optionally additional content, can be packaged as a personalized album by online store 320 and transmitted to recipient(s) 330. If additional content is included in the personalized album that is unique to each recipient, then each recipient receives a uniquely packaged album. In other examples, album metadata, personalized audio files, additional content, and instructions for generating the personalized album can be transmitted to the recipient. The recipient can receive the information on a recipient's device and generate a personalized album in the recipient's media library. By moving the generation of the personalized album to the recipient's device, this helps minimize storage requirements on the online store 320 since a single copy of the audio file can be maintained by online store 320. Instructions to edit the audio file can be stored on online store 320, recipient(s) 330, or cloud storage associated with recipient(s) 330.

As shown here, personalized album 350 has been generated for recipient(s) 330. Personalized album 350 does not contain recipient specific additional content and thus can be the same for multiple recipients. Personalized album 350 includes File A 351 (which is associated with Song A 301), File B 352 (which is associated with Song B 302), and File C 353 (which is associated with Song C 303). Each audio file has modified metadata to specify, for example, that the song belongs to personalized album 350 or that the album was generated by giftor 310. Once the personalized album has been gifted to recipients 330, the recipients can listen to personalized album 350.

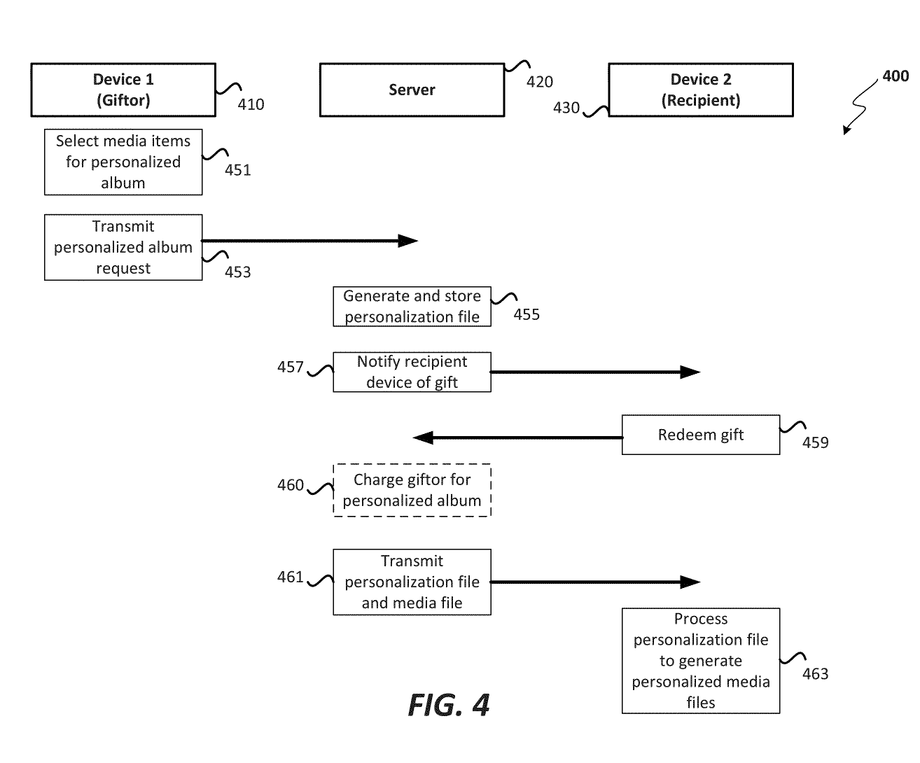

FIG. 4 illustrates an exemplary process for gifting a personalized album to a recipient. Process 400 includes three parties: device 410, which is operated by a giftor server 420, which belongs to an online store; and device 430, which is operated by a recipient. Device 410 specifies the media items and parameters for creating a personalized album in a request to server 420. Server 420 processes the request and cooperates with device 430 to create the personalized album. The personalized album is stored in device 430. Here, a giftor operating device 410 can select media items for a personalized album at 451. The media items can be selected during media playback, from a library of media items on device 410, or from a library of media items on an online store. After selection of the media items, a personalized album request can be transmitted to server 420 at 453. The personalized album request can include attributes of the personalized album such as the album title and the order of the set list (i.e., playback sequence). Once the server receives the request, server 420 can generate and store a personalization file at 455. The personalization file can include data and instructions that are used to generate a personalized album. For example, the data can be attributes, data, or metadata associated with the personalized album including one or more of the following: the playback sequence, album title, cover art for the personalized album, song title, song comment, links to additional content that is to be presented during playback of a media file of the personalized album, and other attributes, data, metadata, or file-specific information associated with the media file. The instructions can be configured to access the data to create the personalized album.

Server 420 transmits a notification to device 430 that a gift album is available for redemption at 457. An operator of device 430 can decide to redeem the gift album, which in turn transmits a redemption signal from device 430 to server 420 at 459. Upon receiving the redemption signal, server 420 can optionally charge the giftor's user account a fee associated with gifting the personalized album at 460. The fee can an album fee that comprises of fees associated with the purchase of each of the media items in the personalized album. For example, a first fee can be associated with purchasing song A 301, of FIG. 3, from a server or online store while a second fee (which can be the same fee or different fee than the first fee) can be associated with purchasing song B 302, of FIG. 3. In some examples, the album fee can also include a personalization fee that is charged by server 420 to for the overhead of generating a personalized album. In other examples, a discount can be applied to the album fee if the number of media items selected for inclusion in the personalized album exceeds a predefined threshold. For instance, selection of 12 songs to include in the personalized album results in a 10% discount to the fees associated with the purchase of the songs. After charging the fee to the giftor's user account, server 420 can transmit the personalization file and media files to the device 430 at 461. In some examples, additional content can also be transmitted to device 430. Using the data received, device 430 generates the personalized album and personalizes the received media files by editing the metadata of the media files at 463. For example, the album title, album artwork, creator, song number, and other metadata can be edited by device 430 in accordance to the instructions provided in the personalization file. Subsequent downloads of the personalized album by device 430 can include performing steps 461 and 463 after a download request is received by server 420 from device 430. In some examples, the subsequent downloads can provide a process for the recipient to download the personalized album to other devices owned by the recipient. In other examples, the steps of process 400 can be performed in a different order.

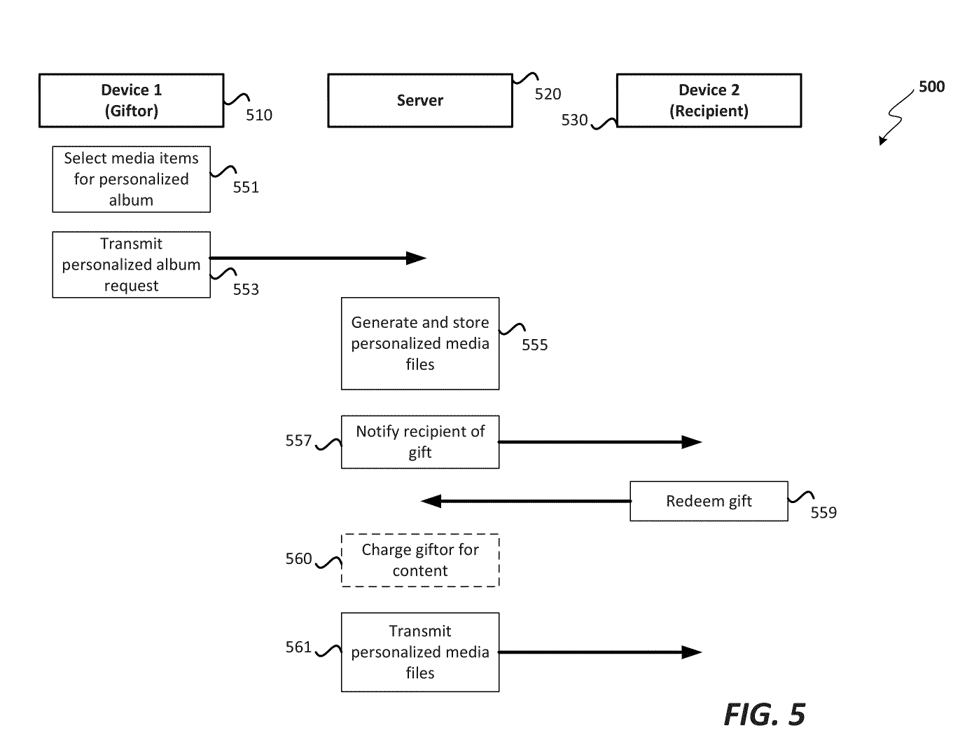

FIG. 5 illustrates another exemplary process for gifting a personalized album to a recipient. Process 500 is similar to process 400, of FIG. 4, except that the personalized media files are stored on the server. Thus, the server maintains multiple copies of a media file; a master copy and one or more personalized copies, where each personalized copy is associated with a personalized album. The copies of the media file can be stored on server 520 or at a remote location accessible by server 520. The personalized copies contain metadata that has been edited to associate the personalized copy to a personalized album. A media player application can organize and present a media library to a user by using the metadata. The results from search requests on the media library are also based on the metadata.

An operator of device 510 can select media items for a personalized album at 551. The operator can also optionally set parameters or attributes of the personalized album such as album title, a playback sequence, or playback options. These selections, parameters, attributes, and options can be transmitted from device 510 to server 520 as a personalized album request at 553. Server 520 processes the request to generate and store personalized media files at 555. The personalized media files are copies of media files on server 520 that have been personalized by editing the metadata of the media files. The server 520 notifies the recipient specified by the giftor that a personalized album is available for redemption by transmitting a notification to device 530 that is operated by the recipient at 557. Device 530 receives the notification and in response to the notification, transmits a response to server 520 that the recipient operating device 530 desires to redeem the personalized album at 559. Server 520 can optionally charge an account associated with the giftor a fee for gifting the personalized album to the recipient at 560. As described above, the fee can be based on the media items in the personalized album, and options or attributes of the personalized album. Server 520 can subsequently transmit the personalized media files associated with the personalized album to device 520 at 561. Upon receiving the personalized media files, device 530 can incorporate the personalized media files into the recipient's media library. The personalized media files may be grouped as belonging to the same album because of similar values in some of their metadata. The personalized media files can be stored on server 520 for subsequent downloads by the recipient to device 530 or other devices operated by the recipient. In other examples, process 500 can include one or more steps of process 400, of FIG. 4, or the steps of process 500 can be performed in a different order.

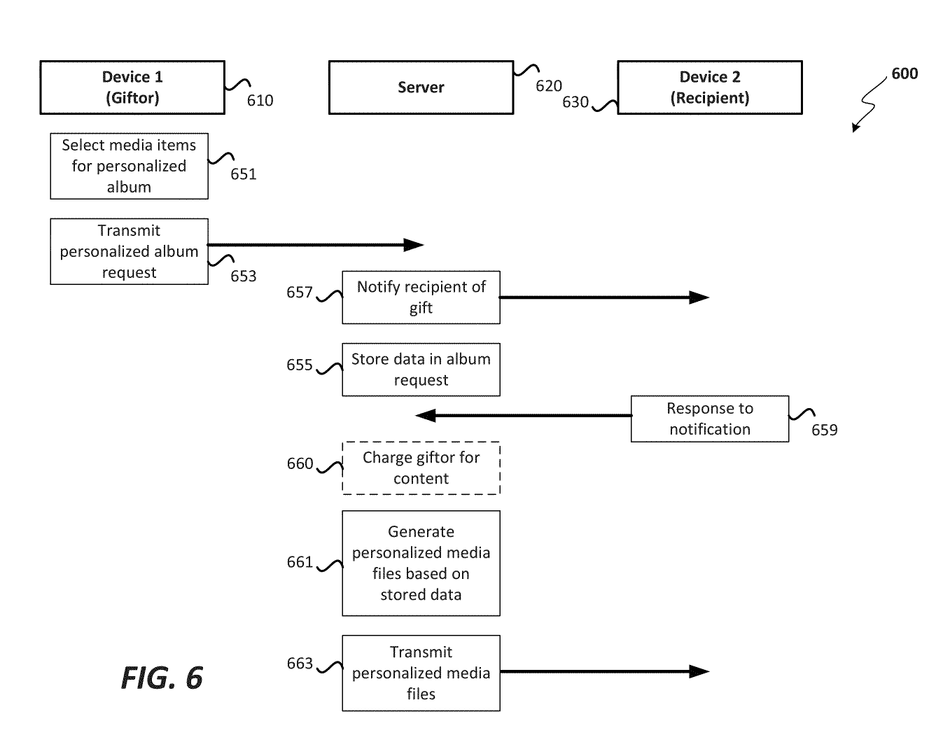

FIG. 6 illustrates another exemplary process for gifting a personalized album to a recipient. Process 600 generates and transmits the personalized media files to a recipient device without saving the personalized media files on server 620. In other words, the personalized media files are not saved on server 620 (as described in process 400) and are not generated by device 630 (as described in process 500).

A giftor operating device 610 selects the options for a personalized album, including selecting the media items to include, the playback sequence of the media items, recipient or recipients of the personalized album, and attributes of the personalized album such as album title, cover art, etc at 651. Device 610 packages the parameters surrounding the personalized album into a personalized album request that is transmitted to server 620 at step 653. In response to receiving the personalized album request, server 620 can notify the recipient of the album that a personalized album is available for redemption at 657. This can include server 620 searching a database or look up table for a device belonging to the recipient and then transmitting a notification to that device. Here, server 620 transmits a notification that a personalized album is available for redemption to device 630 associated with the recipient. If the recipient is associated with multiple devices, server 620 can transmit the notification to one or more of those devices. For instance, a notification can be transmitted to a mobile phone, laptop, and handheld computing device that all belong to the recipient.

After transmitting the notification, server 620 can store the data in the personalized album request on server 620 as it waits for a response from a recipient device at 655. In one example, this can include generating and storing a personalization file. The personalization file contains all the options of the personalized album selected by the giftor in a single file that can be efficiently processed by server 620. In another example, server 620 can store the personalized album request in a database of server 620. The fields of the database can be sorted and searched, thus allowing server 620 to perform queries on the database, such as looking up personalized albums according to the giftor or the recipient. This can be useful during billing for the personalized album or during redemption of the personalized album. Once the data in the personalization album request has been stored, server 620 listens for a redemption request from one of the devices that received the notification.

Server 620 receives a response to the notification from device 630 at 659. In one example, the response is the recipient rejecting the gift. In this scenario, server 620 can delete the stored data for this personalized album request if all recipients of the gift have rejected the gift. If other recipients have not responded to the gift notification or alternatively have accepted the gift, server 620 does not delete the stored data. Although the personalized album was not redeemed by the recipient, the server can still optionally charge the giftor a fee for creating a personalized gift even though the gift was never accepted. In another example, the response is the recipient accepting the gift. In this scenario, server 620 can charge the giftor's user account a fee associated with purchasing the media items in the personalized album and optionally a fee associated with creating a personalized album. As discussed above, a discount may be applied to the fee or fees if the personalized album contains a predetermined number of media items. In yet another example, the response can be the recipient gifting the personalized album to another party. In this scenario, server 620 can update the database storing data in the album request to reflect the change in the recipient party. If this action is undesirable by the giftor (e.g., the giftor wishes to only offer this gift to the recipients he selected), the giftor can set an option to not allow re-gifting when the giftor selects the options for the personalized album. Depending upon the response received from the recipient at 659, server 630 can optionally charge the giftor for content that is accepted, rejected, or re-gifted by the giftor at 660. The amount charged can be calculated using techniques described in this specification.

If the personalized album has been redeemed, server 620 can generate personalized media files in accordance to the stored data associated with the personalized album request at 661. This can include creating copies of the media files associated with the media items in the personalized album and personalizing those copies by editing the metadata in those copies so according to the stored data. This can include changing the album art, album title, creator, and other attributes of the media files. In some examples, the personalized media files can also include additional content that is to be presented to the user before, during, or after playback of the media file. After the personalized media files have been generated, they are transmitted to device 630 by server 620 at 663. Device 630 can in turn incorporate the received media files in its media library. Server 620 may delete the personalized media files after transmission to device 630 to minimize storage overhead on server 620, thus maintaining a single media file for each media item available on server 620. Alternatively, server 620 can store the personalized media files until a response has been received for all outstanding gift notifications. This may improve performance by minimizing processing that potentially is required to generate the personalized media files for each recipient. In other examples, the steps in process 400, 500, and 600, can be interchanged and combined with one another to form other processes for creating and transmitting a personalized album to one or more recipients.

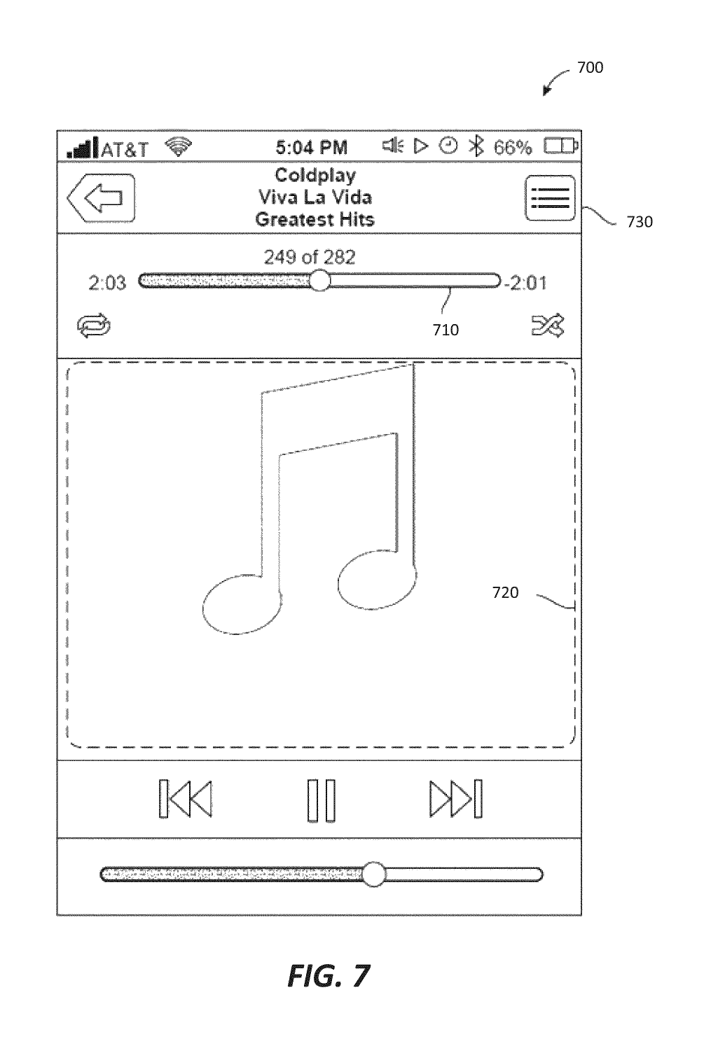

FIG. 7 illustrates an exemplary user interface embodiment for selecting a media item to include in the personalized album. In this example, a listener is playing a song on an electronic device via a media playback application. As shown on display 700, the electronic device is presently playing back an audio file by Coldplay titled “Viva La Vida.” Display 700 can be a media player application running on a laptop computer, desktop computer, portable media player, or smart phone. The media player application includes functionality to create personalized albums (i.e., digital mixed tapes) for one or more recipients. As shown in display 700, a song is currently being played by the media player application. Scrubber bar 710 illustrates that the song is currently at the 2:03 mark. During playback of the song, the media player application can receive a touch input or gesture in touch area 720. The touch input or touch gesture, which originated from a user of a device running the media player application, can be interpreted by the media player application as a command to include the currently playing media item in a playlist of a personalized album. For example, the touch input gesture can be touching and holding touch area 720 on display 700 during playback of media item to generate a pop-up menu and selecting an option in the pop-up menu to include the media item in a personalized album playlist. Alternatively, the media player application can receive a touch input at menu 730 that results in the presentation of a pop-up menu with multiple options, one of the options being configured to command the media player application to include the currently playing media item in the playlist. In other examples, other touch gestures can be received on display 700 to command the media player application to include the currently playing media item in the personalized album playlist. In yet other examples, the songs for the personalized album playlist can be supplemented by a user selecting one or more media items from a media library present on the device or available on an online store.

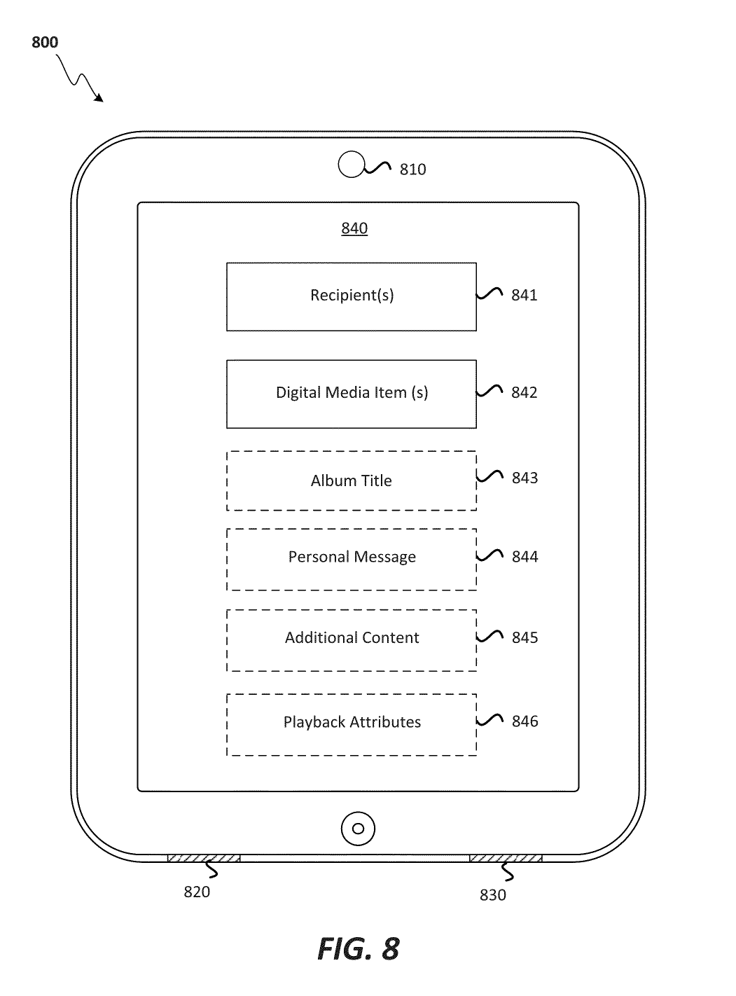

FIG. 8 illustrates an exemplary user interface embodiment for creating a personalized album. As shown here, electronic device 800 can present a fillable form, on display 840, which is configured for creating a personalized album. Once the form has been completed by the giftor, electronic device 800 can transmit the information in the fillable form to a server or online store for processing. Electronic device 800 includes four input/output components: camera 810, speaker 820, microphone 830 and display 840. In other examples, electronic device 800 can have more or fewer input/output components.

The fillable form can present one or more options for setting up and personalizing the album. The fillable form includes field 841 for specifying the recipient or recipients of the album. Field 841 can be populated with an account ID associated with each intended recipient. In a cloud computing system, the recipients and the giftor can have accounts to an online store that is configured to distribute and sell digital media items. Each account can reference an account ID that uniquely identifies the account on the online store. The giftor can gift a personalized album to one or more recipients by specifying the account IDs of the recipients. Upon gifting the personalized album, the giftor can be charged a fee associated with owning a copy of the digital media items in the personalized album. If multiple recipients are gifted the album, the giftor can be charged for each copy gifted. A discount to the fee charged can be applied by the online store when a predefined number of recipients or a predefined number of songs have been selected. In some examples, a search feature is available to assist the giftor in locating the account ID of the recipient.

The fillable form also includes field 842 for specifying the digital media items that are to be included in the personalized album. A digital media item can be selected for inclusion in the personalized album during playback of the digital media item, as described in FIG. 7. A digital media item can also be selected for inclusion from a list of available media items in a media library of the giftor's account or an online store.

The fillable form also includes optional album title field 843 for specifying a title for the personalized album. If the giftor does not specify an album title, a generic album title can be used. The generic album title can be generated by electronic device 800 or the online store. In one embodiment, the generic album title can be generated based on external parameters surrounding the creation of the personalized album. For example, a generic title “Mixed Tape from <giftor's name> created on <date>” can be used. The giftor's name variable is available from the account ID associated with electronic device 800 and the date variable is available from electronic device 800. In another embodiment, the generic album title can be based on the selected digital media items. For example, a generic album title template can be selected from available templates according to the genre of the songs in the personalized album. The most popular genre in the personalized album can be used to select an album title template associated with the genre. For instance, a rock music album title template such as “Rock Music Mixed Tape” can be selected for a personalized album containing mostly rock music. If there are multiple templates available for a given genre, one of the templates can be chosen at random. In other embodiments, a generic album title can be generated from using a mix of the techniques discussed above. For example, a generic album title “Rock Music Mixed Tape created on <date> for <giftor's name>” can be used for a personalized album containing songs that are mostly rock.

The fillable form also includes optional field 844 for including a personal message to the recipient. The personal message can used as part of the notification generated by the server or online store that is sent to the recipient. The personal message can also be used to personalize the album. Depending upon the implementation details, the personal message can be presented before playback of the album or a particular track in the album. The personal message can be an audio, video, or visual note created by the giftor. The giftor can create the personal message by using camera 810, microphone 830 or touch screen display 840 and review the personal message via speaker 820 or display 840. In some examples, camera 810 and microphone 830 can be used, together or independently, to capture digital data. As another example, a user can utilize camera 810 and microphone 830 to record a dedication video speaking to camera 810, or take photos or video. The user can review the photos or video using display 840 and speaker 820. In other embodiments, camera 810 and microphone 830 can be used to create images or videos to be presented during playback of the song, or for personalizing songs or albums (e.g., changing album or song cover art).

The fillable form also includes optional field 845 for attaching additional content to media items in the personalized album. The additional content can be media or content that that is to be presented during playback of a digital media item. In some examples, options for presenting the additional content before, during, or after playback of the digital media item can also be included in field 845. In one embodiment, a server or online store can provide additional content or supplement any existing additional content with content stored on the server or online store. For example, the server can query its database for content associated with a recipient's account ID and automatically attach the queried content with the personalized album or digital media items of the personalized album. In one example, photos containing both the recipient and the giftor can be located on the server and added as additional content to the personalized album. In another example, the server may store special additional content that is only available during gifting of the song. For instance, a gift of “End of the Road” by R.E.M. can include special behind the scenes photos or video that cannot be purchased elsewhere but is available through the gifting process. The photos can be associated with the personalized album or a specific song in the personalized album. During playback of the song, the photos can be presented as a slide show. If the photos are associated with the personalized album rather than individual songs, then all photos can be presented as a continuous slide show regardless of the song in the personalized album that is currently being played.

The fillable form can also include optional field 846 for setting playback attributes. An exemplary playback attribute is enforcing playback of the personalized album to the specified playback sequence. Another exemplary playback attribute is prohibiting skipping of a media item during playback of the personalized album. Another exemplary playback attribute is to reveal the name of each media item after completion of a first playback of the media item. Another exemplary playback attribute is to review the name of all media items after completion of a first playback of the entire personalized album. Yet another exemplary playback attribute can be a delivery date for the personalized album (the date that the personalized album will be available to the recipient) or a different date that each media item in the personalized playlist will become available to the recipient (e.g., a personalized album for Christmas where a new song is available each day up till Christmas). Other exemplary playback attributes can be the playback sequence, how and when the additional content (if any) will be presented during playback, the appearance of the personal message during playback, or other options that can be used to customize the playback experience of the personalized album.

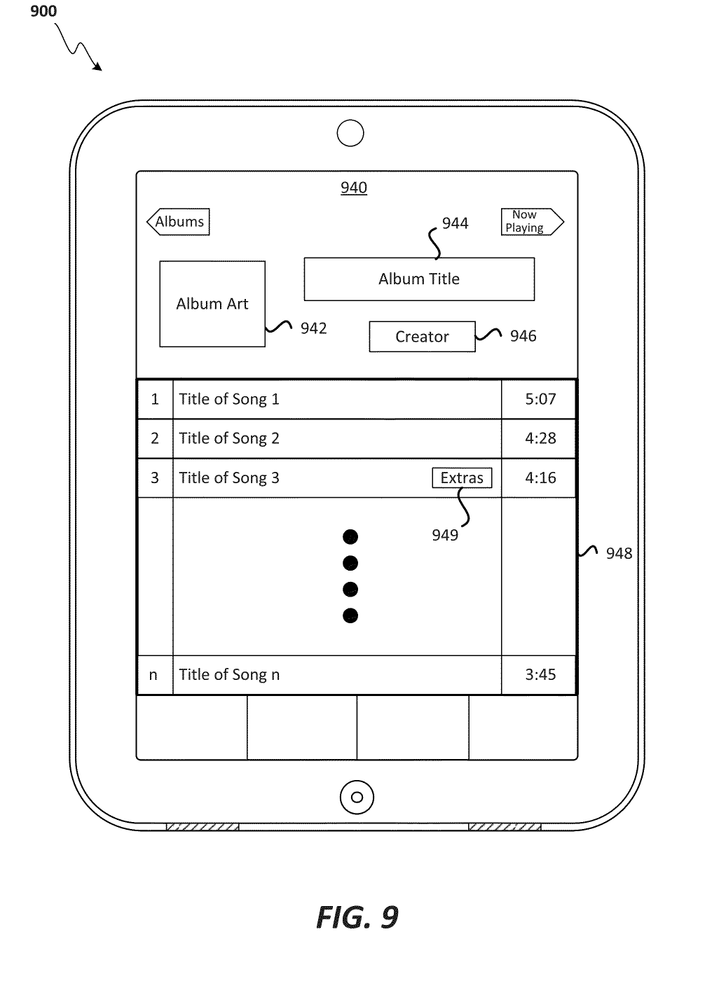

FIG. 9 illustrates an exemplary user interface embodiment for presenting a personalized album. As shown here, electronic device 900 operated by the recipient can present a personalized album on display 940. Display 940 includes album art 942, album title 944, creator 946, a playlist 948, and extras 949. These attributes can be set by the giftor in a personalized album request. Fields not set by the giftor can alternatively be set by an online store or online service providing the personalized album. For example, generic album art can be selected from a pool of available album art. The album art can be selected based on the media items in the album, such as selecting an album art that is for a particular genre. Similarly, the album title 944 and extras 949 can also be automatically generated by the online store. A user can select a song from playlist 948 and play back the selected song. A user can also select album art 942 to enlarge the album art or select extras 949 to review the additional content associated with a song. Song selection can be through a touch interface on display 940. In some embodiments, a user interface similar to FIG. 9 can also be configured for creating a personalized album.

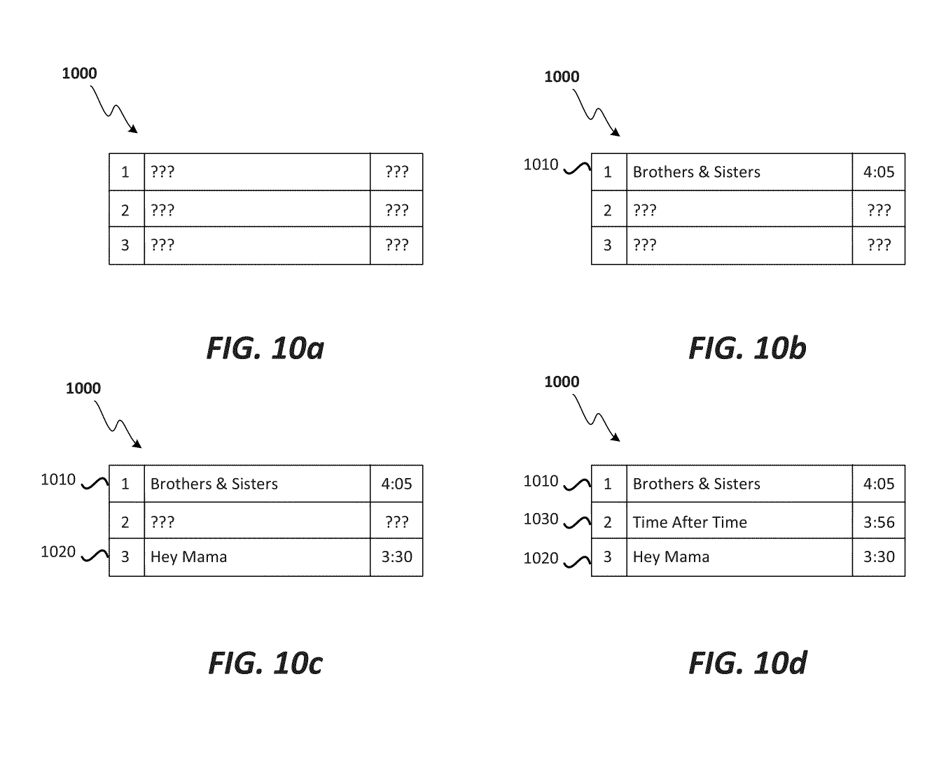

FIGS. 10a-10d illustrate an exemplary personalized album having a playback attribute. As illustrated, playlist 1000 of a personalized album includes three songs. A playback attribute has been set on playlist 1000 to reveal song attributes such as song name or song duration upon completion of a first or initial playback of the song. FIG. 10a illustrates playlist 1000 as it is initially presented to the user. The playlist includes a plurality of songs where each song occupies a row in the playlist. As shown, song attributes have been hidden, thus preventing the listener from discovering the songs in the playlist, similar to an analog mixed tape. FIG. 10b illustrates playlist 1000 after playback of song 1010 has completed. As shown, the song name and the song duration of song 1010 have now been revealed. In various examples, the song attributes can be revealed in the beginning of the song playback, at a predetermined time during the song playback, or after song playback has completed. In one embodiment, song attributes that have been revealed upon initial playback of the song can remain visible for the lifespan of the song. In other words, the song attributes remain visible during the recipient's ownership of the song. Thus, subsequent playback of the album will reveal the attributes of the song. In another embodiment, the song attributes initially remain hidden whenever the personalized album is played. As songs are played back, the song attributes are revealed. If the album is closed and reopened, the previously visible song attributes are hidden once again until playback of the song. FIG. 10c illustrates playlist 1000 after selection and playback of song 1020 has completed. As shown, the song name and song duration for song 1020 has been revealed. In one example, the song attributes can be revealed after half of the song has been played back. In another example, the song attributes can be revealed after the entire song has been played back. FIG. 10d illustrates playlist 1000 after selection and playback of song 1030 has completed. At this point, all songs have been played back and all the song attributes have been revealed.

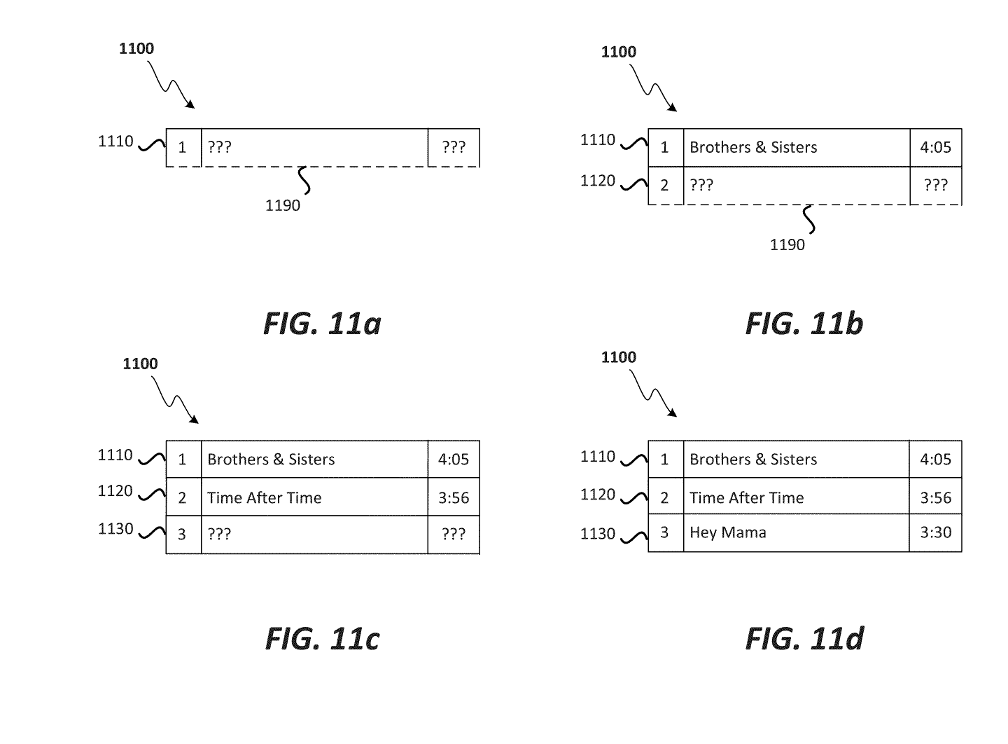

FIGS. 11a-11d illustrate an exemplary personalized album having two playback attributes. As illustrated, playlist 1100 of a personalized album includes three songs. Two playback attributes have been set on playlist 1100. A first attribute reveals song attributes such as song name or song duration upon completion of a first or initial playback of the song. A second attribute enforces playback of the album to a predefined playback sequence. Enforcing playback to a predefined playback sequence restricts playback of the album to the order specified in the predefined playback sequence. FIG. 11a illustrates playlist 1100 as it is initially presented to the user. As shown, playlist 1100 is presented as having one song and the attributes of song 1110 are concealed. Playlist 1100 also includes indicator 1190 (e.g., the dashed line) that is configured to inform a user that playlist 1100 includes additional songs besides song 1110. While a user is aware that playlist 1100 contains additional songs, the user is unaware of exactly how many songs remain. This is similar to an analog mixed tape. In one example, FIG. 11a is presented when playback of song 1110 begins.

FIG. 1 lb illustrates playlist 1100 after playback of song 1110 has completed or alternatively as playback of song 1120 begins. Due to the second attribute, playback of the personalized album is limited to the predefined playback sequence. Thus, one or more user inputs such as fast forwarding, rewinding, and skipping forward or back tracks can be prohibited. As shown, song attributes of song 1110 are visible after playback of song 1110 has completed. However, the song attributes of song 1120 are concealed until the playback of that song has completed. FIG. 11c illustrates playlist 1100 after playback of song 1120 has completed or alternatively after playback of song 1130 begins. As shown, song attributes of song 1120 have been revealed. Playlist 1100 no longer contains indicator 1190. This can queue a user that playlist 1100 does not include additional songs and as such, the song currently being played in the last song. FIG. 1 ld illustrates playlist 1100 after playback of song 1130. As shown, song attribute 1130 is now visible after playback of song 1130. In one example, the song attributes of all songs in playlist 1100 can be concealed until the completed playback of all songs in playlist 1100.

### NOTIFICATIONS

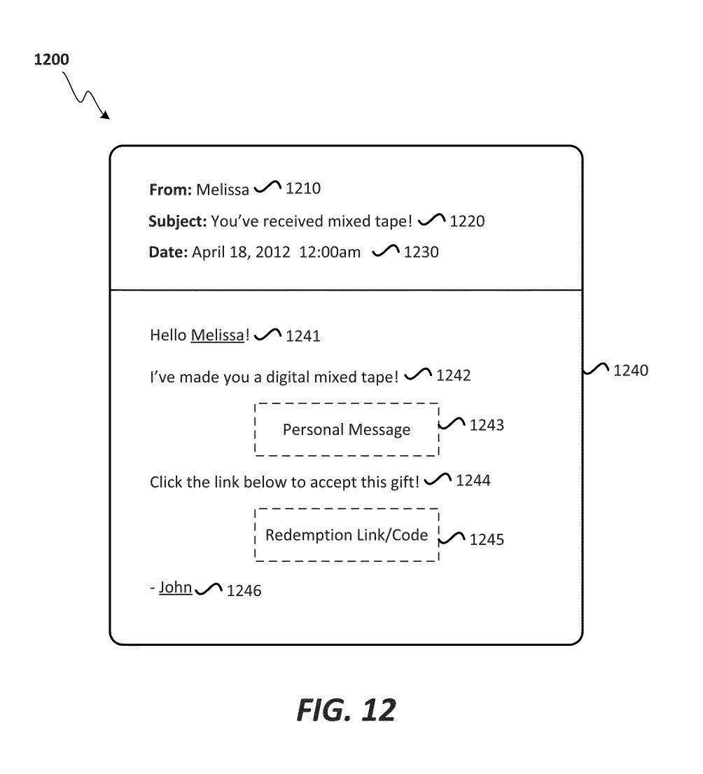

FIG. 12 illustrates an exemplary notification. Notification 1200 is an exemplary email to notify the recipient of that a personalized album is available for redemption. The notification can be transmitted from an online store to an email account associated with the recipient's user account. Alternatively, the notification can also be transmitted from a mail server associated with the giftor's email account to the recipient's email account. Although only electronic notifications are discussed here, it is to be understood by one skilled in the art that printed notifications, such as a card or a photo, can also be generated and sent to the recipient though traditional communication channels. As shown, notification 1200 includes a sender field 1210. Sender field 1210 displays the name of the party that sent the email. In some examples, sender field 1210 can be automatically populated with the name associated with the giftor's user account. Here, sender field 1210 is automatically populated with the name “Melissa.” Notification 1200 can also include subject field 1220. Subject field 1220 provides the recipient a description of the subject matter in this email. In some examples, subject line 1220 can be automatically populated with a generic statement such as “You've received a gift!”, “You've received a mixed tape!”, or “You've received a gift from <giftor's name>!” In other examples, the subject can be manually provided by the giftor. Notification 1200 can also include date stamp 1230. Date stamp 1230 provides information about the time and/or date that the email was sent from the giftor. In some examples where the giftor requests a scheduled delivery, the email can be sent at a date and time specified by the giftor.

Notification 1200 can further include message body 1240. Message body 1240 can be automatically generated, manually generated, or manually generated with portions of the message that are automatically generated. Message body 1240 can include recipient's name 1241, automatically generated text 1242 configured to notify the recipient that a personalized album has been created, a user specified personal message 1243 from the giftor to the recipient, and the name of the giftor 1246. In some examples, the personalized album is automatically associated with the recipient's user account when notification 1200 is sent. Thus, no action is required by the recipient to accept the personalized album. In other examples, the personalized album is associated with the recipient's user account when a redemption message is received at the online store from the recipient. This can open up the possibility of re-gifting or denying a gifted digital media item. In these examples, a redemption link or code 1245 can be included in message body 1240 along with text 1244 describing the link. The redemption link or code 1245 can also include links to accept or deny the gifted digital media item. Based on the response received from the recipient, the online store can associate the gifted digital media item to the recipient's user account, cancel the gift (and potentially not charge the giftor the album fee associated with the personalized album), or notify another party of the gift when the recipient re-gifts the personalized album.

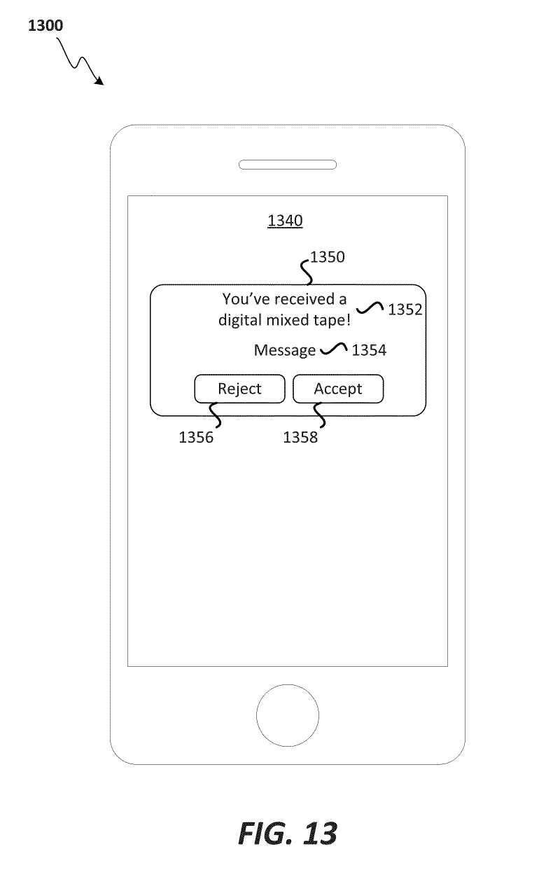

FIG. 13 illustrates another exemplary notification. Notification 1350 is a push notification that is received by electronic device 1300 and displayed on display 1340. A push notification is a communication initiated by the cloud or other central server that is sent to a recipient. Push notifications allow a recipient to receive updates or new messages without having to initiate a request to the central server for communications. Notification 1350 can be a text message that is received on electronic device 1300, a pop-up notification received on electronic device 1300, or other digital message received by electronic device 1300 that is not in response to a request. As shown here, notification 1350 includes title 1352, message 1354, and options 1356 and 1358. Title 1352 can be a title line associated with notification 1350, such as “You've received a digital mixed tape!” Similarly message 1354 can be a message describing the contents of notification 1350 or a personal message from the giftor to the recipient. Message 1354 can be automatically generated or manually generated. For example, the message can state “<Giftor> has gifted you a digital mixed tape titled <title of personalized album>. Would you like to accept the gift?” In some examples, message 1354 can include a redemption code to redeem the gift. In some examples, title 1352 and/or message 1354 can be automatically generated by the device operated by the giftor or the online store.

Options 1356 and 1358 can provide the recipient user-selectable options to respond to the message. There can be more or fewer options depending on the implementation. For example, the recipient can reject the gift by selecting option 1356. By rejecting the gift, electronic device 1300 can inform the online store that the operator of device 1300 has rejected the gift. This can result in a refund of the album fee associated with the gift to the giftor. Alternatively, the user can accept the gift by selecting option 1358. When the user accepts the gift, a message can be sent from electronic device 1300 to inform the online store that the recipient has accepted the gift. As a result, the online store can adjust the ownership rights associated with the recipient's user account accordingly to include the personalized album or the songs of the personalized album. In some examples, selecting option 1358 can link the user to another application configured to manage ownership rights of the recipient. The recipient can review the digital media items owned and decide whether to accept the gift. If the recipient is unsure whether he or she would like to accept or reject the gift, notification 1350 can be saved within electronic device 1300 and a response to notification 1350 can be transmitted to the online store at a later point in time.

In other embodiments, a different notification can be received by the giftor. The notification can be configured to notify the giftor when a predefined event has occurred. For instance, a notification can be received by the giftor (e.g., on an electronic device operated by the giftor) when the recipient of the personalized album plays a song for the first time. The notification can be transmitted from an online store, from the recipient's device, or both. The notification can include a message that informs the giftor that the recipient has listened to a gifted song for the first time and the title of the personalized album that the song belongs to. Thus, this notification can be a receipt of sorts to inform the giftor that a gifted song has been successfully received and played.

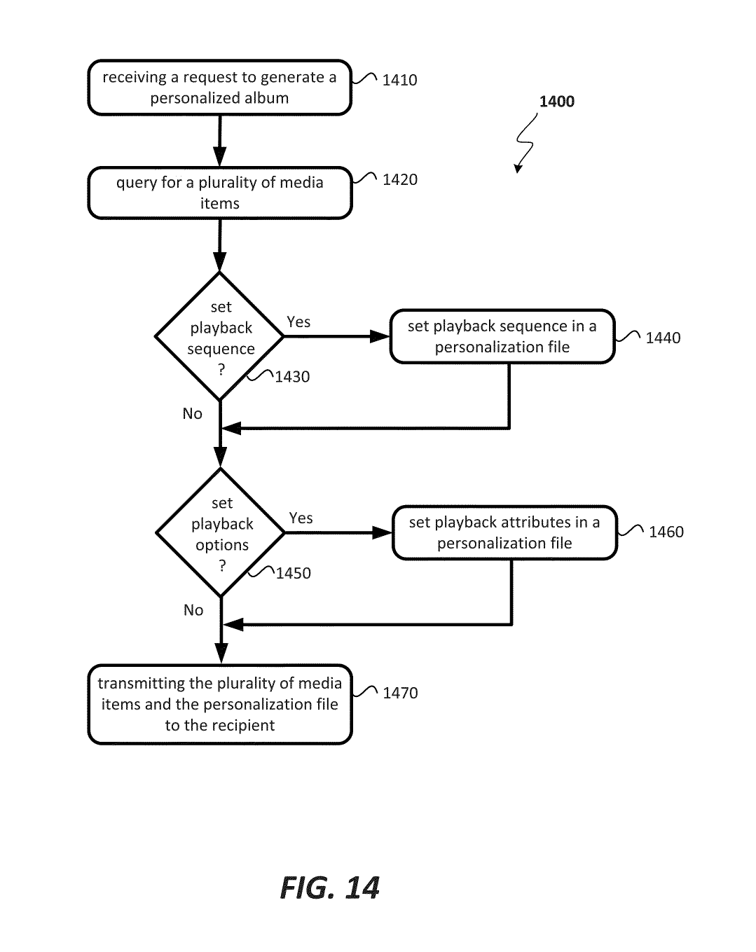

FIG. 14 illustrates an exemplary process for providing a personalized album to a recipient. Process 1400 can be implemented in computer executable code to be executed on a processor. The processor can be part of a server on an online store. Process 1400 begins by receiving a request to generate a personalized album at 1410. In some examples, the request can be received from a first user. The request can include a plurality of media items or specify the plurality of media items that the first user would like to include in the personalized album. The plurality of media items can be selected from media items available in a media library of the first user, media items available in a media library of the online store, or other media items available to the first user. In some examples, the request includes a link to a media item. This is the preferred implementation when the selected media item is available on the online store. In other examples, the request includes a copy of the media item. This is the preferred implementation when the media item is unavailable on the online store. A determination can be made as to which selected media items are available on the online store by comparing the media library of the first user against the media library of the online store. The first user can discover media items available on the online store by transmitting a request to the online store.

After receiving the request, a query is performed for a plurality of media items at 1420. The query can be for media items that were specified for inclusion in the personalized album but were not included in the request. After querying for the media items, process 1400 includes all the media items to be included in the playlist of the personalized album. A determination can be made whether a playback sequence has been included in the request at 1430. The playback sequence can be an order that the songs are to be played back. If a playback sequence has been requested, then the playback sequence can be set in the personalization file at 1440. The personalization file can be configured to provide instructions to create the personalization album by editing the metadata of media items after the media items are transmitted to the gift recipient. Another determination can be made whether playback options have been included in the request at 1450. Playback options include enforcing playback of the album to the playback sequence, revealing media item attributes as the media items are played, and other options to control or restrict playback of the media items as described herein. If playback options are requested, then the playback attributes can be set in the personalization file at 1460. After the personalization file and media items have been collected, the plurality of media items and the personalization file can be transmitted to the recipient at 1470. In some examples, a notification is transmitted to the recipient and an acceptance of the gift is received from the recipient before transmission of the personalization file and the media items.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, solid state drives, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein can be applied other types of files to control the secure deletion of those files and other copies of those files from storage. Those skilled in the art will readily recognize various modifications and changes that may be made to the principles described herein without following the example embodiments and applications illustrated and described herein, and without departing from the spirit and scope of the disclosure.

We claim:

1. A method comprising:
receiving, at a computing device, a personalized media album including a plurality of media items, metadata for each of the media items, and a personalization file that identifies playback options for the personalized media album;
determining, by the computing device, that the playback options include a first option to reveal metadata associated with each of the plurality of media items after each media item has been played by the computing device;
based on the determination:
presenting, on a display of the computing device, a listing of the media items, where the metadata for each media item is obfuscated;
playing, by the computing device, a first media item in the media items;
detecting, by the computing device, that playback of the first media item has concluded; and
in response to the detecting, revealing, on the display of the computing device, the metadata for the first media item.

2. The method of claim 1, wherein presenting a listing of the media items comprises:
presenting a listing of metadata for each media item in the personalized media album;
and prior to playing the first media item for a first time, obfuscating the metadata for the first media item.

3. The method of claim 1, further comprising:
presenting a first name for the first media item before playing the first media item for the first time; and
presenting a second name for the first media item after playing the first media item for the first time, where the first name is a fake name and the second name is an actual name of the first media item.

4. The method of claim 1, further comprising:
after revealing the metadata for the first media item, continuing to obfuscate metadata corresponding to media items in the listing of media items that have not been played by the computing device.

5. The method of claim 1, further comprising:
determining, by the computing device, that the playback options include a second option that restricts playback of the plurality of media items to a specific order; and
playing the media items in the personalized media albums according to the specific order.

6. The method of claim 5, wherein playing the media items according to the specific order comprises:
preventing skipping a media item during playback.

7. The method of claim 5, wherein playing the media items according to the specific order comprises:
preventing fast forwarding a media item during playback.

8. The method of claim 5, wherein playing the media items according to the specific order comprises:
preventing rewinding a media item during playback.

9. A non-transitory computer-readable medium including one or more sequences of instructions which, when executed by one or more processors, cause:
receiving, at a computing device, a personalized media album including a plurality of media items, metadata for each of the media items, and a personalization file that identifies playback options for the personalized media album;
determining, by the computing device, that the playback options include a first option to reveal metadata associated with each of the plurality of media items after each media item has been played by the computing device;
based on the determination:
presenting, on a display of the computing device, a listing of the media items, where the metadata for each media item is obfuscated;
playing, by the computing device, a first media item in the media items;
detecting, by the computing device, that playback of the first media item has concluded; and
in response to the detecting, revealing, on the display of the computing device, the metadata for the first media item.

10. The non-transitory computer-readable medium of claim 9, wherein the instructions that cause presenting a listing of the media items include instructions that cause:
presenting a listing of metadata for each media item in the personalized media album; and prior to playing the first media item for a first time, obfuscating the metadata for the first media item.

11. The non-transitory computer-readable medium of claim 9, wherein the instructions cause:
presenting a first name for the first media item before playing the first media item for the first time; and
presenting a second name for the first media item after playing the first media item for the first time, where the first name is a fake name and the second name is an actual name of the first media item.

12. The non-transitory computer-readable medium of claim 9, wherein the instructions cause:
after revealing the metadata for the first media item, continuing to obfuscate metadata corresponding to media items in the listing of media items that have not been played by the computing device.

13. The non-transitory computer-readable medium of claim 9, wherein the instructions cause:
determining, by the computing device, that the playback options include a second option that restricts playback of the plurality of media items to a specific order; and
playing the media items in the personalized media albums according to the specific order.

14. The non-transitory computer-readable medium of claim 13, wherein the instructions that cause playing the media items according to the specific order include instructions that cause:
preventing skipping a media item during playback.

15. The non-transitory computer-readable medium of claim 13, wherein the instructions that cause playing the media items according to the specific order include instructions that cause:
preventing fast forwarding a media item during playback.

16. The non-transitory computer-readable medium of claim 13, wherein the instructions that cause playing the media items according to the specific order include instructions that cause:
preventing rewinding a media item during playback.

17. A system comprising:
one or more processors; and
a non-transitory computer-readable medium including one or more sequences of instructions which, when executed by one or more processors, cause:
receiving, at a computing device, a personalized media album including a plurality of media items, metadata for each of the media items, and a personalization file that identifies playback options for the personalized media album;
determining, by the computing device, that the playback options include a first option to reveal metadata associated with each of the plurality of media items after each media item has been played by the computing device;
based on the determination:
presenting, on a display of the computing device, a listing of the media items, where the metadata for each media item is obfuscated;
playing, by the computing device, a first media item in the media items;
detecting, by the computing device, that playback of the first media item has concluded; and
in response to the detecting, revealing, on the display of the computing device, the metadata for the first media item.

18. The system of claim 17, wherein the instructions that cause presenting a listing of the media items include instructions that cause:
presenting a listing of metadata for each media item in the personalized media album; and prior to playing the first media item for a first time, obfuscating the metadata for the first media item.

19. The system of claim 17, wherein the instructions cause:
presenting a first name for the first media item before playing the first media item for the first time; and
presenting a second name for the first media item after playing the first media item for the first time, where the first name is a fake name and the second name is an actual name of the first media item.

20. The system of claim 17, wherein the instructions cause:
after revealing the metadata for the first media item, continuing to obfuscate metadata corresponding to media items in the listing of media items that have not been played by the computing device.

21. The system of claim 17, wherein the instructions cause:
determining, by the computing device, that the playback options include a second option that restricts playback of the plurality of media items to a specific order; and
playing the media items in the personalized media albums according to the specific order.

22. The system of claim 21, wherein the instructions that cause playing the media items according to the specific order include instructions that cause:
preventing skipping a media item during playback.

23. The system of claim 21, wherein the instructions that cause playing the media items according to the specific order include instructions that cause:
preventing fast forwarding a media item during playback.
